(19) United States
(12) Patent Application Publication
(10) Pub. No.: US 2024/0170675 A1
(43) Pub. Date: May 23, 2024

(54) BINDER FOR LITHIUM-SULFUR ELECTRODE, POSITIVE ELECTRODE INCLUDING THE SAME, AND LITHIUM-SULFUR SECONDARY BATTERY INCLUDING THE SAME

(71) Applicant: KOREA ELECTRONICS TECHNOLOGY INSTITUTE, Seongnam-si (KR)

(72) Inventors: Je Nam LEE, Seongnam-si (KR); Sang Gil WOO, Suwon-si (KR)

(21) Appl. No.: 18/489,566

(22) Filed: Oct. 18, 2023

(30) Foreign Application Priority Data
Nov. 15, 2022 (KR) 10-2022-0152548

(51) Int. Cl. H01M 4/62; H01M 4/36; H01M 4/58; H01M 4/583; H01M 10/052

(52) U.S. Cl. CPC H01M 4/623; H01M 4/364; H01M 4/5815; H01M 4/583; H01M 10/052; H01M 2004/028

(57) ABSTRACT

A binder for a lithium-sulfur electrode is proposed. The binder can improve the capacity and lifespan characteristics of a lithium-sulfur secondary battery by suppressing the shuttle reaction due to the elution of polysulfide through the interaction of lithium polysulfide while maintaining the binding characteristics of the binder. This binder may be used for a positive electrode and a lithium-sulfur secondary battery. The binder may include a modified polyvinylidene fluoride (PVdF)-based binder that is soluble in an organic solvent. The modified PVdF-based binder may include a PVdF-based main chain and a functional group having a carboxylic group or carbonyl group grafted as a side chain.

### CROSS REFERENCE TO RELATED APPLICATIONS

The present application claims priority to Korean Patent Application No. 10-2022-0152548 filed Nov. 15, 2022, the entire contents of which are incorporated herein for all purposes by this reference.

### BACKGROUND

### Technical Field

The present disclosure relates to a lithium-sulfur secondary battery.

### Description of Related Technology

As consumer demands change towards the digitalization and high performance of electronic products, market demands are also shifting towards the development of batteries with thinness, weight reduction, and high capacity by high energy density. In addition, in order to cope with future energy and environmental issues, the development of hybrid electric vehicles, electric vehicles, and fuel cell vehicles is actively underway, so that there is a demand for larger batteries for vehicle power sources.

### SUMMARY

One aspect is a binder for a lithium-sulfur electrode, which can improve the capacity and lifespan characteristics of a lithium-sulfur secondary battery by suppressing the shuttle reaction due to the elution of polysulfide through the interaction of lithium polysulfide while maintaining the binding characteristics of the binder.

Another aspect is a positive electrode and lithium-sulfur secondary battery including the binder.

Another aspect is a binder for a lithium-sulfur electrode includes a modified polyvinylidene fluoride (PVdF)-based binder that is soluble in an organic solvent. The modified PVdF-based binder includes a PVdF-based main chain and a functional group having a carboxylic group or carbonyl group grafted as a side chain.

The modified PVdF-based binder may be a binder in which a functional group according to Chemical Formula below is grafted as the side chain:

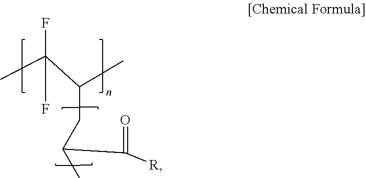

wherein R is OH, OCH₃ or H.

The modified PVdF-based binder may include PVdF-g-PAA.

The binder may further include a polymer binder selected from ethylene propylene dienterpolymer (EPDM), acetonitrile butadiene (AB), polyisoprene, polybutadiene, polyvinylpyrrolidone (PVP), polyacrylate-based, polyurethane-based, epoxy resin-based, polyester-based, silicone resin-based, polyamide-based, polyvinylidene fluoride (PVDF), and polytetraethylene fluoride (PTEF).

The binder may include 1 to 100 wt % of the modified PVdF-based binder and 0 to 99 wt % of the polymer binder.

In addition, according to the present disclosure, a positive electrode for a lithium-sulfur secondary battery includes a sulfur/carbon composite, a conductive agent, and the above-described binder.

The positive electrode may contain 1 to 50 wt % of the modified PVdF-based binder.

Another aspect is a lithium-sulfur secondary battery that includes a positive electrode including a sulfur/carbon composite, a conductive agent, and the above-described binder; a negative electrode based on lithium; a separator disposed between the positive electrode and the negative electrode; and an electrolyte.

According to the present disclosure, by applying the modified PVdF-based binder soluble in an organic solvent to the binder forming the positive electrode, it is possible to suppress the shuttle reaction resulting from the elution of polysulfide through the interaction of lithium polysulfide while maintaining the binding characteristics of the binder, and thus improve the capacity and lifespan characteristics of the lithium-sulfur secondary battery.

That is, since the modified PVdF-based binder according to the present disclosure contains a functional group that can interact with lithium polysulfide soluble in an organic solvent, it is possible to manufacture high loading electrodes of 8 mg/cm² or more even if the total binder content in the positive electrode is maintained at 5 wt %, for example.

In addition, the modified PVdF-based binder according to the present disclosure can effectively control the electrolyte elution of polysulfide because a functional group having a carboxylic group or carbonyl group capable of interacting with lithium polysulfide is grafted as the side chain.

### BRIEF DESCRIPTION OF THE DRAWINGS

FIG. 1 is a diagram illustrating a lithium-sulfur secondary battery according to the present disclosure.

FIG. 2 is a graph showing the charge/discharge characteristics of lithium-sulfur secondary batteries according to an embodiment and a comparative example.

FIG. 3 is a graph showing the lifespan characteristics of lithium-sulfur secondary batteries according to an embodiment and a comparative example.

### DETAILED DESCRIPTION

Lithium-based secondary batteries have been put into practical use as small, lightweight and high-capacity rechargeable batteries, and are being used in a variety of portable electronic and communication devices such as small video cameras, mobile phones, and notebook computers. A lithium secondary battery consists of a positive electrode, a negative electrode, and an electrolyte. Lithium ions released from the positive electrode by charging are inserted into the negative electrode and are then released again during discharging, thereby transferring energy by traveling back and forth between the two electrodes, making charging and discharging possible.

However, existing lithium secondary batteries have several problems such as safety issues due to overheating, low energy density of about 200 to 250 Wh/kg, and low output.

In order to solve these problems of existing lithium secondary batteries, research and development on lithium-sulfur secondary batteries that can realize high output and high energy density are actively underway. For example, lithium-sulfur secondary batteries can achieve high energy density because of using sulfur, which has high capacity per mass, as the positive electrode material.

The basic system of lithium-sulfur secondary batteries is to use sulfur as the positive electrode and lithium as the negative electrode. As the discharge process progresses, sulfur is reduced to Li₂S through the state of lithium polysulfide (Li₂Sₓ; LiPS). When charging, it goes through a process of returning to the sulfur (S₈) state.

In this process, a shuttle reaction of dissolved lithium polysulfide occurs, causing a side reaction with the lithium electrode, and the proportion of actively acting positive electrode active material is reduced, resulting in a rapid deterioration in capacity and performance.

To solve these problems, in terms of a positive electrode active material, research is being conducted to control the amount of lithium polysulfide eluted from the structure by creating a carbon/sulfur composite. However, in terms of a binder, the introduction of the carbon/sulfur composite can cause a decrease in the binding force of the binder, and as the loading of the electrode increases, the content of the binder to maintain the electrode increases.

If the binder content increases as such, it may cause a decrease in the capacity and energy density of the electrode. Additionally, as the loading of the electrode increases, the amount of lithium polysulfide dissolved in the electrolyte also increases, affecting the lifespan characteristics of the lithium-sulfur secondary battery.

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

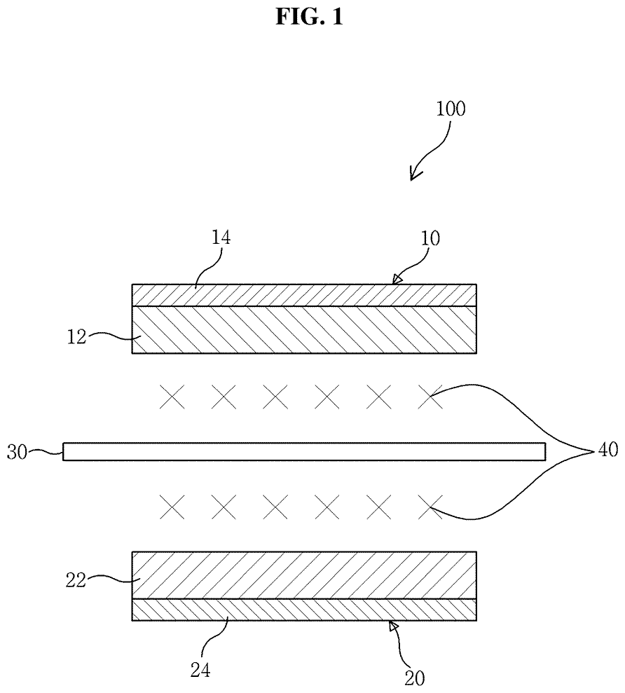

FIG. 1 is a diagram illustrating a lithium-sulfur secondary battery according to the present disclosure.

Referring to FIG. 1, the lithium-sulfur secondary battery 100 according to the present disclosure has a structure in which a positive electrode assembly 10 and a negative electrode assembly 20 are disposed on both sides of a separator 30 and an electrolyte 40 is contained therebetween.

The positive electrode assembly 10 includes a positive electrode 12 and a positive electrode current collector 14.

The positive electrode assembly 10 is capable of generating and consuming electrons through an electrochemical reaction, and performs a function of providing electrons to an external circuit through the positive electrode current collector 14.

The positive electrode 12 is based on a sulfur material, and includes a binder to fix the sulfur material and a conductive agent to improve electronic conductivity.

The sulfur material may include elemental sulfur (S₈), a sulfur-based compound, a sulfur/carbon complex, or a mixture thereof. The sulfur-based compound may include Li₂Sn (n≥1), an organic sulfur compound, a carbon-sulfur polymer ((C₂Sₓ)n: x=2.5˜50, n≥2), or the like. In the present disclosure, a sulfur/carbon composite is used as the sulfur material.

As the conductive agent, a carbon-based material such as carbon black, acetylene black, or Ketjen black may be used.

The binder includes a modified polyvinylidene fluoride (PVdF)-based binder that is soluble in an organic solvent. In the modified PVdF-based binder, the main chain is PVdF-based, and a functional group having a carboxylic group or carbonyl group is grafted as the side chain.

The modified PVdF-based binder may be a binder in which a functional group according to Chemical Formula 1 below is grafted as the side chain. For example, the modified PVdF-based binder may include PVdF-g-PAA.

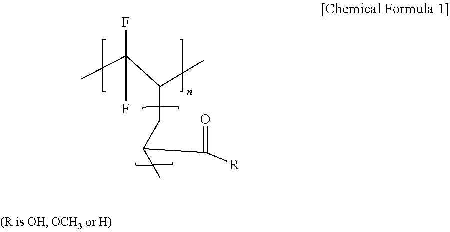

The positive electrode 12 may contain 1 to 50 wt % of a modified PVdF-based binder.

Since the modified PVdF-based binder used as the binder according to the present disclosure has a functional group that interacts with lithium polysulfide, it is possible to manufacture high loading electrodes of 8 mg/cm² or more even if the total binder content in the positive electrode 12 is maintained at 5 wt %, for example.

In addition, the binder according to the present disclosure may further include a polymer binder selected from ethylene propylene dienterpolymer (EPDM), acetonitrile butadiene (AB), polyisoprene, polybutadiene, polyvinylpyrrolidone (PVP), polyacrylate-based, polyurethane-based, epoxy resin-based, polyester-based, silicone resin-based, polyamide-based, polyvinylidene fluoride (PVDF), and polytetraethylene fluoride (PTEF).

The binder according to the present disclosure may include 1 to 100 wt % of a modified PVdF-based binder and 0 to 99 wt % of a polymer binder. That is, by applying 1 wt % or more of a modified PVdF-based binder soluble in an organic solvent to the binder forming the positive electrode 12, it is possible to suppress the shuttle reaction resulting from the elution of poly sulfide through the interaction of lithium poly sulfide while maintaining the binding characteristics of the binder, and thus improve the capacity and lifespan characteristics of the lithium-sulfur secondary battery 100.

The positive electrode current collector 14 performs a function of collecting electrons generated by the electrochemical reaction of the positive electrode 12 or supplying electrons necessary for the electrochemical reaction. As the positive electrode current collector 14, foamed aluminum or foamed nickel, which have excellent conductivity, may be used.

The negative electrode assembly 20 may include a negative electrode 22 and a negative electrode current collector 24.

The negative electrode 22 is formed on the side of the negative electrode current collector 24 facing the separator 30. The negative electrode 22 is functionally capable of generating and consuming electrons through the electrochemical reaction, and performs a function of providing electrons to an external circuit through the negative electrode current collector 24.

The negative electrode 22 has a negative electrode material as its main composition. As the negative electrode material, a material capable of reversibly intercalating or deintercalating lithium ions, such as a material selected from the group consisting of lithium metal and lithium alloy that can react with lithium ions to reversibly form a lithium-containing compound, may be used.

The material capable of reversibly intercalating and deintercalating lithium ions may be a carbon material such as a carbon-based material commonly used in the lithium-sulfur secondary battery 100. For example, the carbon-based material may include crystalline carbon, amorphous carbon, or a combination thereof.

The material that can react with lithium ions to reversibly form a lithium-containing compound may include, but is not limited to, tin oxide (SnO₂), titanium nitrate, and silicon (Si).

The alloy of lithium metal may specifically be an alloy of lithium and metal of Si, Al, Sn, Pb, Zn, Bi, In, Mg, Ga, or Cd.

The negative electrode current collector 24 performs a function of collecting electrons generated by the electrochemical reaction of the negative electrode material or supplying electrons necessary for the electrochemical reaction. The negative electrode current collector 24 may be formed of a material selected from the group consisting of copper, aluminum, stainless steel, titanium, silver, palladium, nickel, alloys thereof, and combinations thereof. Here, stainless steel may be surface-treated with carbon, nickel, titanium or silver. An aluminum-cadmium alloy may be used as the alloy. In addition, the negative electrode current collector 24 may be formed of calcined carbon, a non-conductive polymer surface-treated with a conductive agent, or a conductive polymer.

The separator 30 is a member that separates the positive electrode assembly 10 and the negative electrode assembly 20 to prevent short circuiting due to direct contact, and is interposed between the positive electrode assembly 10 and the negative electrode assembly 20. The separator 30 not only simply separates the positive electrode assembly 10 and the negative electrode assembly 20, but also plays an important role in improving stability.

The electrolyte 40 performs a function of allowing lithium used as the negative electrode material to be dissolved in a solvent made of an organic solvent and dissociated into ions to flow current.

The electrolyte 40 contains lithium salt and an organic solvent.

The organic solvent may be a polar solvent such as an aryl compound, bicyclic ether, acyclic carbonate, sulfoxide compound, lactone compound, ketone compound, ester compound, sulfate compound, sulfite compound, or the like. For example, the electrolyte solvent may include, but is not limited to, dimethoxyethane (DME), dioxolane (DOL), triethylene glycol dimethyl ether (TEGDME), or diethylene glycol dimethyl ether (DEGDME).

The lithium salt may include LiPF₆, LiBF₄, LiClO₄, LITFSI, LiNO₃, LiCF₃SO₃, LiAsF₆, LiN(CF₃SO₂)₂, LiN(C₂F₅SO₂)₂, LiTDI, or the like.

### Embodiment and Comparative Example

In order to confirm the electrochemical properties of the lithium-sulfur secondary battery including the modified PVdF-based binder according to the present disclosure and the positive electrode to which the modified PVdF-based binder is applied, binders according to an embodiment and a comparative example were prepared as follows and the experiment was performed.

In the comparative example 1, PVdF was used as a binder, and in the embodiment 1, PVdF-g-PAA was used as a binder.

The positive electrodes according to the comparative example 1 and the embodiment 1 were prepared to have the following composition ratio. Here, ‘S/C’ represents sulfur/carbon complex, and ‘super-p’ stands for carbon black.

S/C:PVdF-g-PAA:super-p=90:5:5, L/L=7.6 mg/cm² [Embodiment 1]

S/C:PVdF:super-p=90:5:5, Li/L=7.6 mg/cm² [Comparative Example 1]

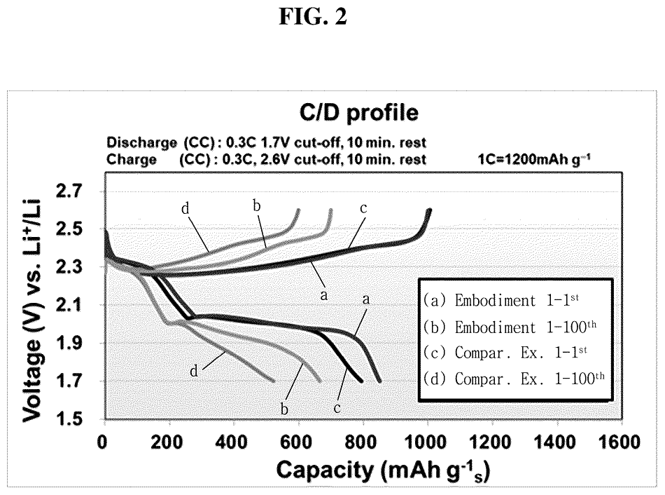

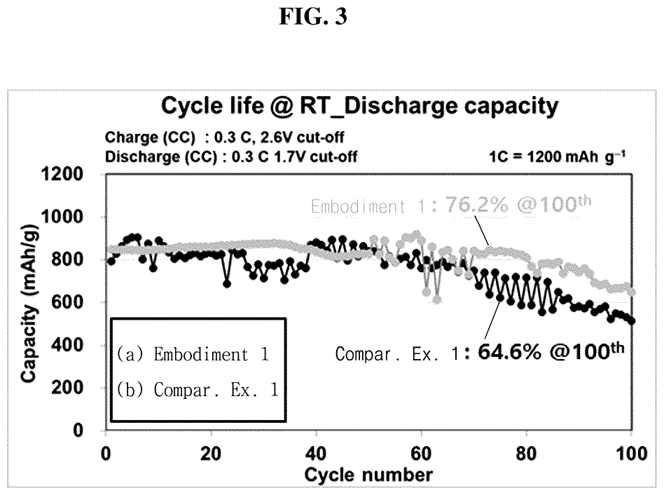

Li—S single-cell cells were manufactured by applying the binder according to the embodiment 1 and the comparative example 1 as above, and the charge/discharge characteristics and 0.3C long-term lifespan were evaluated. The charge/discharge characteristics are shown in FIG. 2, and the long-term lifespan characteristics are shown in FIG. 3.

FIG. 2 is a graph showing the charge/discharge characteristics of lithium-sulfur secondary batteries according to an embodiment and a comparative example.

Referring to FIG. 2, it can be seen that the discharge capacity in the embodiment 1 was increased during charging and discharging behavior compared to the comparative example 1.

FIG. 3 is a graph showing the lifespan characteristics of lithium-sulfur secondary batteries according to an embodiment and a comparative example.

Referring to FIG. 3, the capacity retention rate after 100 cycles of operation was 64.6% in case of the comparative example 1, and it was 76.2% in case of the embodiment 1.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A binder for a lithium-sulfur electrode, comprising:
a modified polyvinylidene fluoride (PVdF)-based binder that is soluble in an organic solvent,
the modified PVdF-based binder including a PVdF-based main chain and a functional group having a carboxylic group or carbonyl group grafted as a side chain.

2. The binder of claim 1, wherein the modified PVdF-based binder is a binder in which a functional group according to Chemical Formula below is grafted as the side chain: 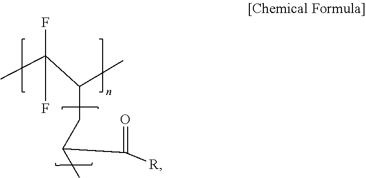
wherein R is OH, OCH₃ or H.

3. The binder of claim 1, wherein the modified PVdF-based binder includes PVdF-g-PAA.

4. The binder of claim 1, further comprising:
a polymer binder selected from one or more of ethylene propylene dienterpolymer (EPDM), acetonitrile butadiene (AB), polyisoprene, polybutadiene, polyvinylpyrrolidone (PVP), polyacrylate-based, polyurethane-based, epoxy resin-based, polyester-based, silicone resin-based, polyamide-based, polyvinylidene fluoride (PVDF), or polytetraethylene fluoride (PTEF).

5. The binder of claim 4, wherein the binder includes 1 wt % to 100 wt % of the modified PVdF-based binder and 0 wt % to 99 wt % of the polymer binder.

6. A positive electrode for a lithium-sulfur secondary battery, comprising:
a sulfur/carbon composite;
a conductive agent; and
a binder including a modified polyvinylidene fluoride (PVdF)-based binder that is soluble in an organic solvent, the modified PVdF-based binder including a PVdF-based main chain and a functional group having a carboxylic group or carbonyl group grafted as a side chain.

7. The positive electrode of claim 6, wherein the modified PVdF-based binder is a binder in which a functional group according to Chemical Formula below is grafted as the side chain: 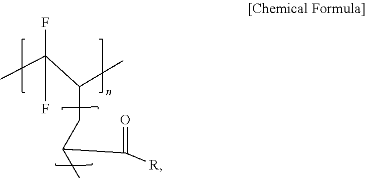
wherein R is OH, OCH₃ or H.

8. The positive electrode of claim 6, wherein the modified PVdF-based binder includes PVdF-g-PAA.

9. The positive electrode of claim 6, wherein the positive electrode contains 1 to 50 wt % of the modified PVdF-based binder.

10. The positive electrode of claim 6, wherein the binder further includes a polymer binder selected from one or more of ethylene propylene dienterpolymer (EPDM), acetonitrile butadiene (AB), polyisoprene, polybutadiene, polyvinylpyrrolidone (PVP), polyacrylate-based, polyurethane-based, epoxy resin-based, polyester-based, silicone resin-based, polyamide-based, polyvinylidene fluoride (PVDF), or polytetraethylene fluoride (PTEF).

11. The positive electrode of claim 10, wherein the binder includes 1 wt % to 100 wt % of the modified PVdF-based binder and 0 wt % to 99 wt % of the polymer binder.

12. A lithium-sulfur secondary battery comprising:
a positive electrode including a sulfur/carbon composite, a conductive agent, and a binder;
a negative electrode based on lithium;
a separator disposed between the positive electrode and the negative electrode; and
an electrolyte,
wherein the binder of the positive electrode includes a modified polyvinylidene fluoride (PVdF)-based binder that is soluble in an organic solvent, the modified PVdF-based binder including a PVdF-based main chain and a functional group having a carboxylic group or carbonyl group grafted as a side chain.

13. The lithium-sulfur secondary battery of claim 12, wherein the modified PVdF-based binder is a binder in which a functional group according to Chemical Formula below is grafted as the side chain: 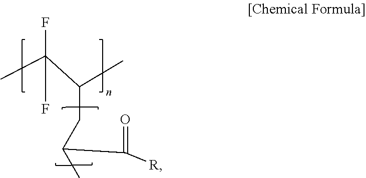
wherein R is OH, OCH₃ or H.

14. The lithium-sulfur secondary battery of claim 12, wherein the modified PVdF-based binder includes PVdF-g-PAA.

15. The lithium-sulfur secondary battery of claim 12, wherein the positive electrode contains 1 wt % to 50 wt % of the modified PVdF-based binder.

16. The lithium-sulfur secondary battery of claim 12, wherein the binder further includes a polymer binder selected from one or more of ethylene propylene dienterpolymer (EPDM), acetonitrile butadiene (AB), polyisoprene, polybutadiene, polyvinylpyrrolidone (PVP), polyacrylate-based, polyurethane-based, epoxy resin-based, polyester-based, silicone resin-based, polyamide-based, polyvinylidene fluoride (PVDF), and polytetraethylene fluoride (PTEF).

17. The lithium-sulfur secondary battery of claim 16, wherein the binder includes 1 wt % to 100 wt % of the modified PVdF-based binder and 0 wt % to 99 wt % of the polymer binder.
